(19) United States
(12) Patent Application Publication
(10) Pub. No.: US 2009/0110947 A1
(43) Pub. Date: Apr. 30, 2009

(54) APPARATUS AND METHOD OF DECORATING A SURFACE OF A WORKPIECE AND DECORATED PART

(75) Inventors: Chien-Min Chang, Taipei City (TW); Yu-Lun Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 11/930,135

(22) Filed: Oct. 31, 2007

(51) Int. Cl. B32B 33/00; B32B 37/02; B32B 37/06; B32B 37/26

(52) U.S. Cl. 428/542.2; 156/230; 156/567; 156/583.1

(57) ABSTRACT

A method of decorating a surface of a workpiece includes the step of positioning a decorating film over the surface, wherein the decorating film has a first side and an opposite second side with a decorating pattern facing the surface. The decorating film is then fitted tightly on the surface by applying negative pressure therebetween. Next, the decorating pattern is transferred onto the surface by providing a heated gas current to heat the decorating film.

### BACKGROUND OF THE INVENTION

1. Field of the Invention

The present invention generally relates to a method of image transferring, in particular, to a method of decorating a surface.

2. Description of Related Art

Manufacturers now a day require image transferring techniques for embellishing and labelling their products. Decorating products not only give the products unique and stylish appearances, but also achieve other functions, anti-pirating among them. In order to satisfy the demand of embellishing and labelling the products, various image transferring techniques have heretofore been developed and employed. Thermal transfer, among others, is a wide accepted technique to decorate a product.

FIG. 1 illustrates a conventional thermal transferring process. Referring to FIG. 1, the conventional thermal transferring process involves the following steps: first, disposing a decorating film 110 with a decorating pattern 112 on a workpiece 120; second, pressurizing the decorating film 110 to fix the decorating film 110 on a surface 122 of the workpiece 120; last, rolling a roller 130 over the surface of the workpiece 120 to heat the decorating film 110 and thus transfer the decorating pattern 112 onto the surface of the workpiece 120.

Despite thermal transfer is one of the most accepted decorating techniques, nevertheless, it has several drawbacks. Firstly, thermal transfer utilizes a roller to heat the decorating film, and thus the coverage is limited to the size of the roller. To paraphrase, the recesses or concaves of the surface smaller than the roller are improbable to be reached. Furthermore, the roller must be in contact with the decorating film to heat it, the impact of the roller, however, is highly probable to cause damage to the surface.

### SUMMARY OF THE INVENTION

Accordingly, the present invention is directed to a method of decorating a surface of a workpiece, which provides higher surface coverage and prevents the surface from damage.

The present invention provides a method of decorating a surface of a workpiece includes the step of positioning a decorating film over the surface, wherein the decorating film has a first side and an opposite second side with a decorating pattern facing the surface. The decorating film is then fitted tightly on the surface by applying negative pressure therebetween. Next, the decorating pattern is transferred onto the surface by providing a heated gas current to heat the decorating film.

According to an embodiment of the present invention, the heated gas current provided applies positive pressure to the first side of the decorating film provides.

According to an embodiment of the present invention, the method further includes the step of removing the decorating film from the surface after the decorating pattern is transferred onto the surface.

According to an embodiment of the present invention, the method further includes the step of softening the decorating film before fitting the decorating film tightly on the surface.

According to an embodiment of the present invention, the step of softening the decorating film includes heating.

According to an embodiment of the present invention, the decorating film is a portion of a tape, and an untransferred segment of the tape connecting one end of the portion is wound on a spool, while a transferred segment of the tape connecting the other end of the portion is wound on another spool.

According to an embodiment of the present invention, the step of positioning the decorating film includes disposing the decorating film on a top mold by inserting a plurality of pilot rods of the top mold into a plurality of pilot holes of the decorating film individually, and disposing a positioning frame on the top mold to hold the decorating film between the top mold and the positioning frame.

According to an embodiment of the present invention, the step of fitting the decorating film includes moving the positioning frame and the top mold toward a bottom mold, on which the workpiece is mounted, and providing negative pressure between the bottom mold, the top mold and the decorating film to fit the decorating film tightly on the surface of the workpiece.

According to an embodiment of the present invention, the workpiece is mounted on a replaceable portion of the bottom mold.

According to an embodiment of the present invention, the step of transferring the decorating pattern includes disposing a cover on the positioning frame to form a closed space defined by the cover, the positioning frame and the decorating film, and the heated gas current is then provided in the closed space to heat the decorating film.

According to an embodiment of the present invention, the heated gas current provided applies positive pressure to the decorating film.

According to an embodiment of the present invention, the step of removing the decorating film includes lifting the top mold and the positioning frame to remove the decorating film from the workpiece after the decorating pattern is transferred onto the surface.

The present invention further provides an apparatus for decorating a surface of a workpiece. The apparatus comprises a bottom mold, a negative pressure provider, a top mold, a decorating film, and a heated gas current provider. The workpiece is disposed on the bottom mold, which has at least one via, and the negative pressure provider is connected to the via. The top mold is disposed on the bottom mold, exposing the surface of the workpiece. The decorating film has a first side with a decorating pattern and an opposite second side, where the decorating film is disposed on the top mold and over the workpiece exposed by the top mold, with the first side facing the workpiece. The heated gas current provider is adapted for providing a heated gas current to the second side of the decorating film.

According to an embodiment of the present invention, the apparatus further includes a first spool and a second spool, wherein the two ends of the decorating film wound on the first spool and the second spool respectively.

According to an embodiment of the present invention, the decorating film has a plurality of pilot holes, and the top mod has a plurality of pilot rods, which are capable of inserting into the pilot holes.

According to an embodiment of the present invention, the apparatus further includes a positioning frame, disposed on the top mold, wherein the decorating film is held between the positioning frame and the top mold.

According to an embodiment of the present invention, the apparatus further includes a cover, disposed on the positioning frame, and form a closed space defined by the cover, the positioning frame and the decorating film.

According to an embodiment of the present invention, the bottom mold further has a plurality of guiding tunnels, and the top mold has a plurality of guiding pins, which are capable of inserting into and move along the guiding tunnel.

According to an embodiment of the present invention, the bottom mold further has a replaceable portion.

The present invention further provides a decorated part comprising a workpiece and a decorating pattern disposed thereon. The workpiece has a surface including at least one riser portion and at least one tread portion. The decorating pattern disposed on the surface and tightly fitted on the riser portion, the tread portion, and the junction between the riser portion and the tread portion.

As described above, in the present invention, the method utilizes heated gas current to heat the decorating film and thus transfers the decorating pattern onto the surface of the workpiece. Since gas molecules in the heated gas current are sufficiently small, hence is capable of decorating the surface thoroughly. Furthermore, substituting heated gas for the roller prevents the contact between the surface and the roller, and thus keeps the surface from damages caused by the impact of the roller.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a conventional thermal transferring process.

FIG. 2A to FIG. 2F are diagrams illustrating a method of decorating a surface of a workpiece according to an embodiment in the present invention.

FIG. 3 is a cross-sectional view of a decorated workpiece according to an embodiment in the present invention.

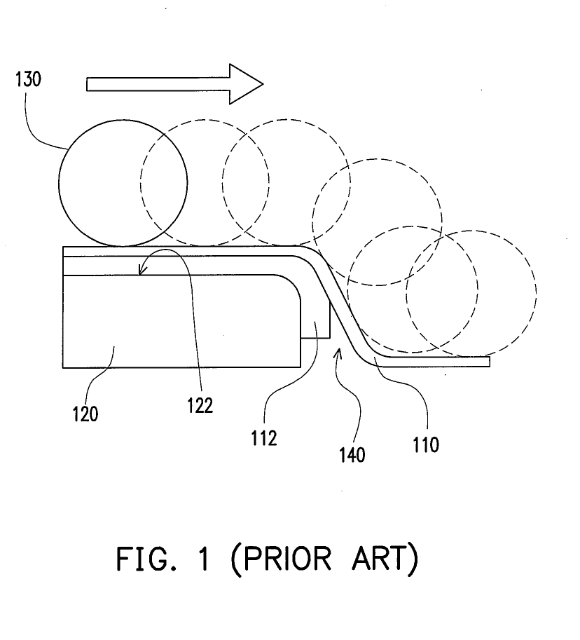

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

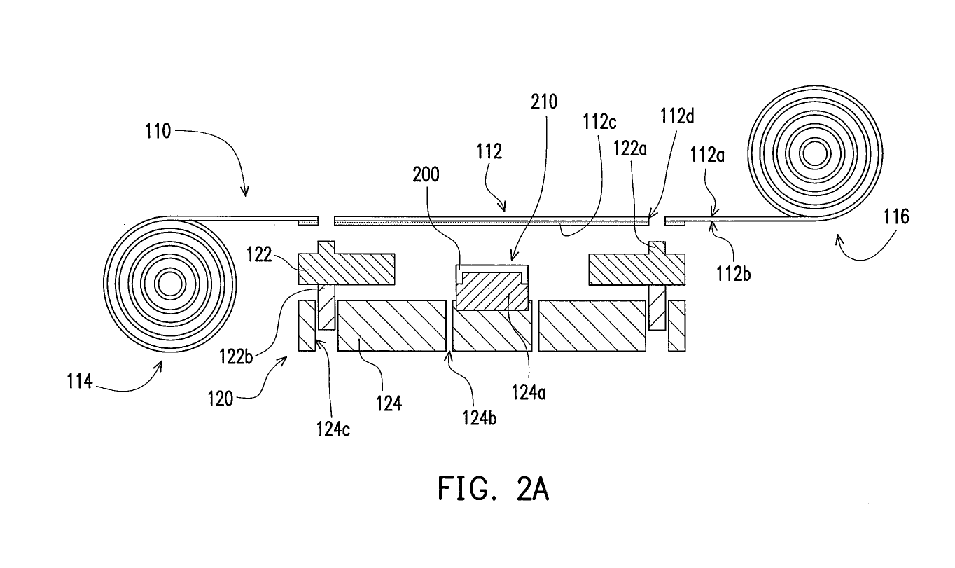

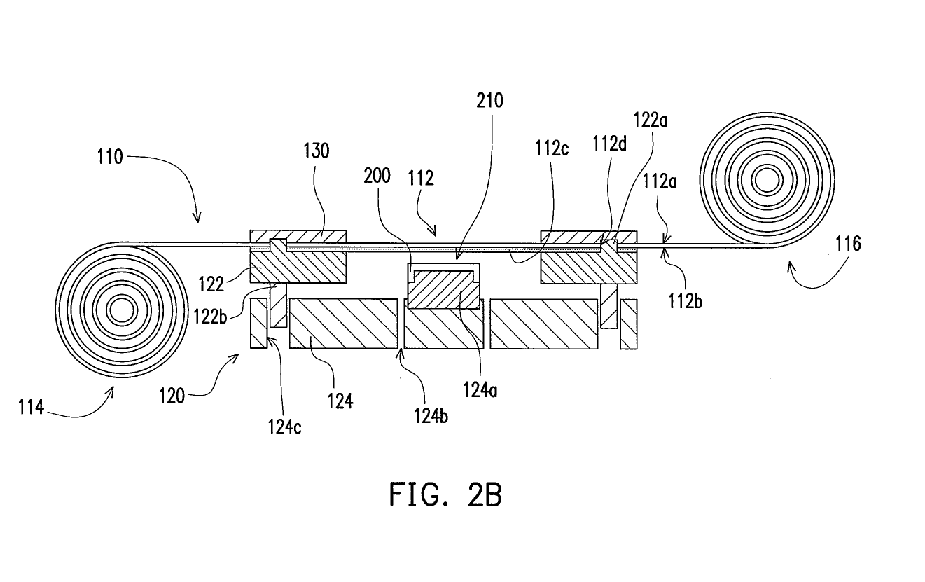

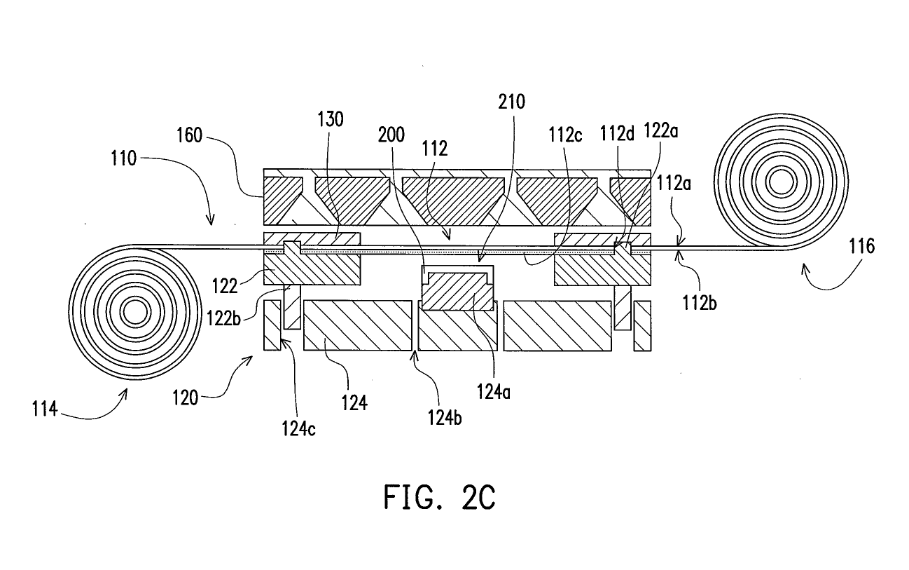

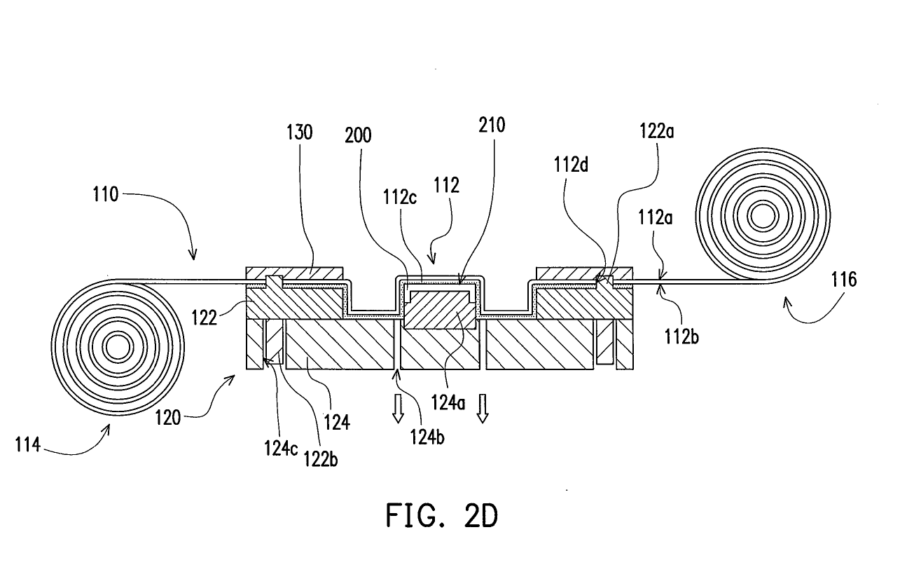

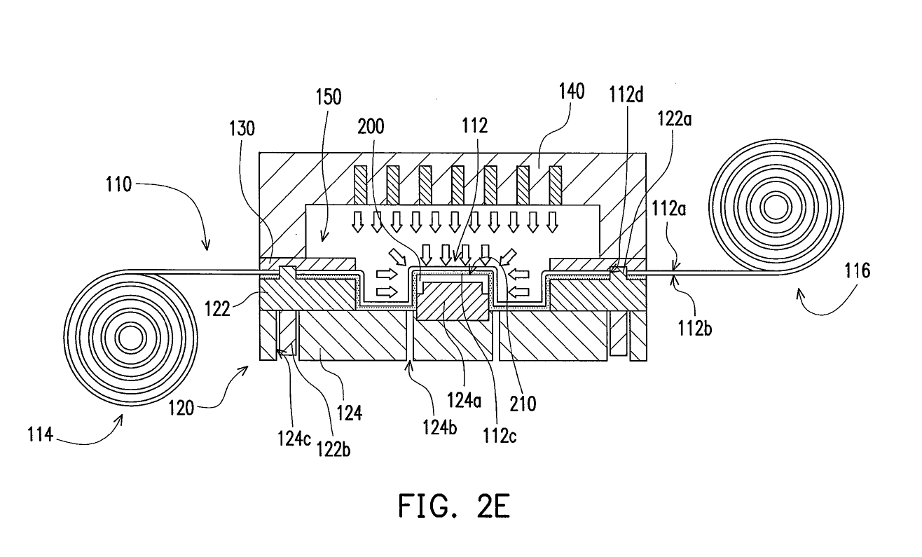

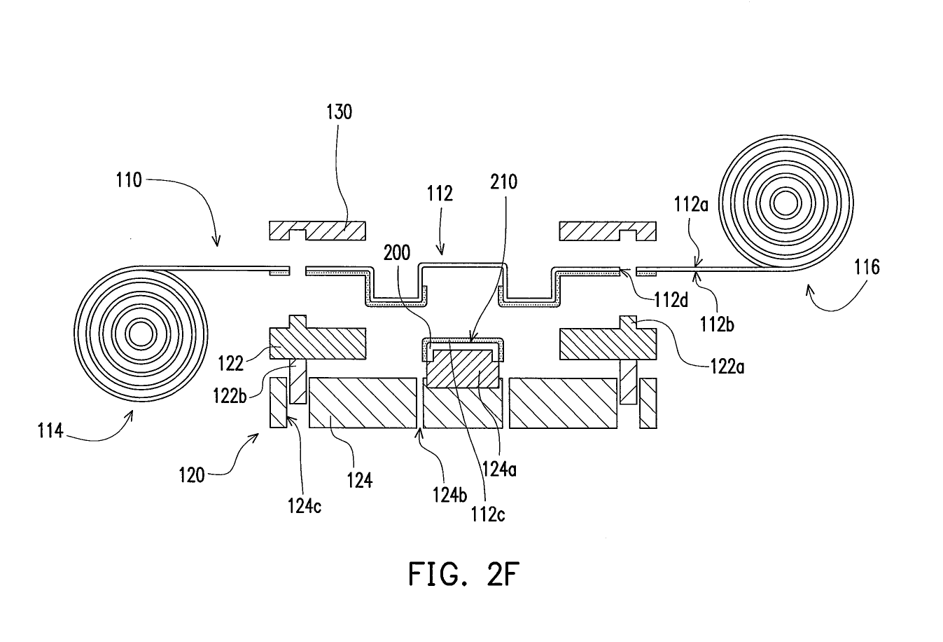

FIG. 2A to FIG. 2F are diagrams illustrating a method of decorating a surface of a workpiece according to an embodiment in the present invention. It is to be noted that, despite the decorating film 112 revealed in the present embodiment is a portion of a tape 110, and an untransferred segment of the tape 110 connecting one end of the portion is wound on a first spool 114, while a transferred segment of the tape 110 connecting the other end of the portion is wound on a second spool 116, however, other types of decorating film is also applicable, such as a single piece of decorating film.

The method includes the following steps: first, referring to FIG. 2A, positioning a decorating film 112 over the surface 210 of the workpiece 200, in which the decorating film 112 has a first side 112a and an opposite second side 112b with a decorating pattern 112c facing the surface 210. Referring to FIG. 2B, The step of positioning the decorating film 112 may include disposing the decorating film 112 on a top mold 122 by inserting a plurality of pilot rods 122a of the top mold into a plurality of pilot holes 112d of the decorating film 112 individually, and disposing a positioning frame 130 on the top mold 122 to hold the decorating film 112 between the top mold 122 and the positioning frame 130.

Referring to FIG. 2C, the method may further include a step of softening the decorating film 112, such as heating the decorating film 112, in case the decorating film 112 is inflexible and unable to be fitted before being heated.

Referring to FIG. 2D, the decorating film 112 is then fitted on the surface 210 tightly by applying negative pressure between the second side 112b of the decorating film 112 and the surface 210. The step of fitting the decorating film 112 may include moving the positioning frame 130 and the top mold 122 toward a bottom mold 124, on which the workpiece 200 is mounted, and providing negative pressure between the bottom mold 124, the top mold 122 and the second side 112b of the decorating film 112 to fit the decorating film 112 tightly on the surface 210 of the workpiece 200. The positioning frame 130 may be moved along a plurality of guiding pins 122b of the top mold 122, which are inserted in a plurality of corresponding guiding tunnels 124c of the bottom mold 124. In addition, the negative pressure may be applied via the through holes 124b of the bottom mold 124. What is more, the bottom mold 124 may have a replaceable portion 124a, on which the workpiece may be disposed, where the replaceable portion 124a of bottom mold 124 can be switched to suit different shapes of manifold workpieces.

Referring to FIG. 2E, the decorating pattern 112c is then transferred onto the surface 210 by providing a heated gas current to heat the decorating film 112. The step of transferring the decorating pattern 112c may include disposing a cover 140 on the positioning frame 130 to form a closed space 150 defined by the cover 140, the positioning frame 130 and the decorating film 112. Then, the heated gas current is provided in the closed space 150 and applied to the decorating film 112 on the first side 112a in order to heat the decorating film 112 and thus transfer the decorating pattern 112c onto the surface 210. Moreover, the heated gas current provided to the decorating film 112 may apply positive pressure to the decorating film 112 on the first side 112a and further fastens the decorating film 112 on the surface 210.

Referring to FIG. 2F, the method may further include a step of removing the decorating film 112 from the surface 210, such as lifting the top mold 122 and the positioning frame 130 to remove the decorating film 112, after the decorating pattern 112c is transferred onto the surface 210.

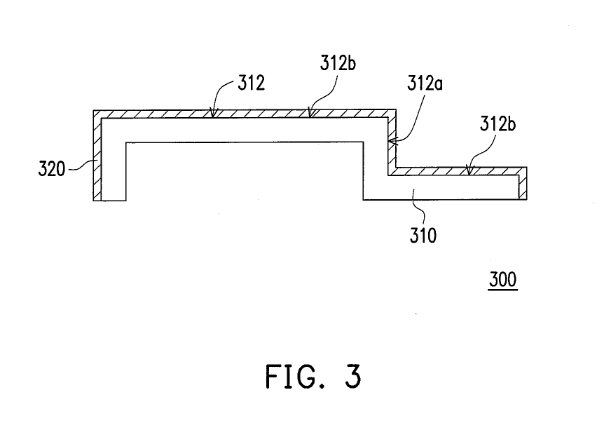

FIG. 3 is a cross-sectional view of a decorated part according to an embodiment in the present invention. Referring to FIG. 3, the decorated part 300 decorated with the aforementioned method comprises a workpiece 310 and a decorating pattern 320. The workpiece has a surface 312, which includes a riser portion 312a and a plurality of tread portions 312b. The decorating pattern 320 is tightly fitted on the riser portion 312a and the tread portions 312b, and also the junction between the riser portion 312a and the tread portions 312b because of utilizing the method of decorating mentioned above. The method introduced replaces the conventional roller with heated gas current, which can reach the region that can not be reached by the conventional roller; therefore, the decorating pattern can be tightly fitted on the whole surface 312, even the junction between the riser portion 312a and the tread portions 312b, which is not probable to be decorated using conventional method.

It is to be noticed that the number of tread portion and the number of the riser portion is not limited in this embodiment, people having ordinary skill in the art may employ other shape of the workpiece, which may include other numbers of tread portion and other numbers of riser portion.

In summary, in the present invention, a heated gas current is provided to heat the decorating film and thus transfers the decorating pattern onto the surface of the workpiece. Since the gas current is utilized instead of roller, hence the surface can be decorated thoroughly. Furthermore, substituting heated gas for the roller prevents the contact between the surface and the roller, and thus lest the damages to the surface resulting from the impact of the roller.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of decorating a surface of a workpiece, comprising:
positioning a decorating film over the surface, wherein the decorating film has a first side and an opposite second side with a decorating pattern facing the surface;
fitting the decorating film tightly on the surface by applying negative pressure therebetween; and
transferring the decorating pattern onto the surface by providing a heated gas current to heat the decorating film.

2. The method according to claim 1, wherein the heated gas current provided applies positive pressure to the first side of the decorating film.

3. The method according to claim 1, further comprising:
removing the decorating film from the surface after the decorating pattern is transferred onto the surface.

4. The method according to claim 1, further comprising:
softening the decorating film before fitting the second side of the decorating film tightly on the surface.

5. The method according to claim 4, wherein the step of softening the decorating film includes heating.

6. The method according to claim 1, wherein the decorating film is a portion of a tape and an untransferred segment of the tape connecting one end of the portion is wound on a spool, while a transferred segment of the tape connecting the other end of the portion is wound on another spool.

7. The method according to claim 1, wherein the step of positioning the decorating film comprises:
disposing the decorating film on a top mold by inserting a plurality of pilot rods of the top mold into a plurality of pilot holes of the decorating film individually; and
disposing a positioning frame on the top mold to hold the decorating film between the top mold and the positioning frame.

8. The method according to claim 7, wherein the step of fitting the decorating film comprises:
moving the positioning frame and the top mold toward a bottom mold, on which the workpiece is mounted; and
providing negative pressure between the bottom mold, the top mold and the decorating film to fit the decorating film tightly on the surface of the workpiece.

9. The method according to claim 8, wherein the workpiece is mounted on a replaceable portion of the bottom mold.

10. The method according to claim 8, wherein the step of transferring the decorating pattern comprises:
disposing a cover on the positioning frame to form a closed space defined by the cover, the positioning frame and the decorating film; and
providing the heated gas current in the closed space to heat the decorating film.

11. The method according to claim 10, wherein the heated gas current provided applies positive pressure to the decorating film.

12. The method according to claim 8, wherein the step of removing the decorating film comprises:
lifting the top mold and the positioning frame to remove the decorating film from the workpiece after the decorating pattern is transferred onto the surface.

13. An apparatus for decorating a surface of a workpiece, comprising:
a bottom mold, on which the workpiece is disposed, has at least one via;
a negative pressure provider, connected to the via;
a top mold, disposed on the bottom mold, and exposes the surface of the workpiece;
a decorating film, disposed on the top mold and over the workpiece exposed by the top mold, wherein the decorating film has a first side with a decorating pattern facing the workpiece and an opposite second side; and
a heated gas current provider, adapted for providing a heated gas current to the second side of the decorating film.

14. The apparatus according to claim 13, further includes a first spool and a second spool, wherein the two ends of the decorating film wound on the first spool and the second spool respectively.

15. The apparatus according to claim 13, wherein the decorating film has a plurality of pilot holes, and the top mod has a plurality of pilot rods, which are capable of inserting into the pilot holes.

16. The apparatus according to claim 15, further includes a positioning frame, disposed on the top mold, wherein the decorating film is held between the positioning frame and the top mold.

17. The apparatus according to claim 16, further includes a cover, disposed on the positioning frame, and form a closed space defined by the cover, the positioning frame and the decorating film.

18. The apparatus according to claim 13, wherein the bottom mold further has a plurality of guiding tunnels, and the top mold has a plurality of guiding pins, which are capable of inserting into and move along the guiding tunnel.

19. The apparatus according to claim 13, wherein the bottom mold further has a replaceable portion.

20. A decorated part, comprising:
a workpiece, having a surface including at least one riser portion and at least one tread portion; and
a decorating pattern, disposed on the surface, tightly fitting on the riser portion, the tread portion, and the junction between the riser portion and the tread portion.
